(19) United States
(12) Patent Application Publication
(10) Pub. No.: US 2026/0129643 A1
(43) Pub. Date: May 7, 2026

(54) USER EQUIPMENT UPLINK BEAM REPORTING IN WIRELESS COMMUNICATIONS

(71) Applicant: QUALCOMM Incorporated, San Diego, CA (US)

(72) Inventors: Kiran VENUGOPAL, Green Brook, NJ (US); Yan ZHOU, San Diego, CA (US); Tao LUO, San Diego, CA (US); Raghu Narayan CHALLA, San Diego, CA (US); Ruhua HE, San Diego, CA (US)

(21) Appl. No.: 18/940,678

(22) Filed: Nov. 7, 2024

(51) Int. Cl. H04W 72/21

(52) U.S. Cl. CPC H04W 72/21

(57) ABSTRACT

Methods, systems, and devices for wireless communications are described that provide for updated uplink beam reports from a user equipment (UE). A UE may detect a changed condition associated with uplink communications, and may transmit a request for an update of a beam report to provide one or more uplink parameters. Such a UE may detect one or more changed conditions, such as due to a changed uplink beam pattern or uplink power backoff, and may request to update an uplink beam report or both an uplink and downlink beam report. A network entity may receive the request, and transmit an indication to the UE of an uplink resource for transmission of the uplink beam report, and the UE may transmit the uplink beam report using the indicated uplink resource.

### TECHNICAL FIELD

The following relates to wireless communications, including user equipment uplink beam reporting in wireless communications.

### DESCRIPTION OF THE RELATED TECHNOLOGY

Wireless communications systems are widely deployed to provide various types of communication content such as voice, video, packet data, messaging, broadcast, and so on. These systems may be capable of supporting communication with multiple users by sharing the available system resources (for example, time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communication. The method includes receiving configuration information that indicates the UE can transmit a request to provide an uplink measurement report for one or more uplink parameters associated with an uplink channel between the UE and a network entity, transmitting the request to provide the uplink measurement report in accordance with a change in at least one of the one or more uplink parameters relative to a prior uplink measurement report, receiving a resource allocation for transmission of the uplink measurement report, and transmitting the uplink measurement report using uplink resources indicated in the resource allocation.

Another innovative aspect of the subject matter described in this disclosure can be implemented in a UE for wireless communication. The UE may include one or more memories storing processor executable code, and one or more processors coupled with the one or more memories. The one or more processors may individually or collectively be operable to execute the code to cause the UE to receive configuration information that indicates the UE can transmit a request to provide an uplink measurement report for one or more uplink parameters associated with an uplink channel between the UE and a network entity, transmit the request to provide the uplink measurement report in accordance with a change in at least one of the one or more uplink parameters relative to a prior uplink measurement report, receive a resource allocation for transmission of the uplink measurement report, and transmit the uplink measurement report using uplink resources indicated in the resource allocation.

Another innovative aspect of the subject matter described in this disclosure can be implemented in a UE for wireless communication. The UE may include means for receiving configuration information that indicates the UE can transmit a request to provide an uplink measurement report for one or more uplink parameters associated with an uplink channel between the UE and a network entity, means for transmitting the request to provide the uplink measurement report in accordance with a change in at least one of the one or more uplink parameters relative to a prior uplink measurement report, means for receiving a resource allocation for transmission of the uplink measurement report, and means for transmitting the uplink measurement report using uplink resources indicated in the resource allocation.

Another innovative aspect of the subject matter described in this disclosure can be implemented in a non-transitory computer-readable medium storing code for wireless communication. The code may include instructions executable by one or more processors to receive configuration information that indicates a UE can transmit a request to provide an uplink measurement report for one or more uplink parameters associated with an uplink channel between the UE and a network entity, transmit the request to provide the uplink measurement report in accordance with a change in at least one of the one or more uplink parameters relative to a prior uplink measurement report, receive a resource allocation for transmission of the uplink measurement report, and transmit the uplink measurement report using uplink resources indicated in the resource allocation.

In some examples of the method, UEs, and non-transitory computer-readable medium described herein, the one or more uplink parameters include a beam pattern of an uplink beam, an uplink power backoff at the UE for uplink transmissions via one or more uplink beams, a set of available uplink antenna ports at the UE, or any combination thereof. In some examples of the method, UEs, and non-transitory computer-readable medium described herein, the request to provide the uplink measurement report may be indicated by a request field in an uplink control information transmission, a configured uplink control channel resource, one or more request bits of a downlink beam measurement report, an uplink random access channel resource, an uplink random access channel preamble, or any combination thereof.

In some examples of the method, UEs, and non-transitory computer-readable medium described herein, the configuration information indicates that the request is to be transmitted using one or more of an uplink control information transmission, a scheduling request, a random access message using a random access resource configured for transmitting the request, or a random access preamble that indicates the request. In some examples of the method, UEs, and non-transitory computer-readable medium described herein, the resource allocation may be received in a downlink control information message that indicates an uplink resource for transmission of the uplink measurement report, and the downlink control information message may have a format associated with the uplink measurement report.

In some examples of the method, UEs, and non-transitory computer-readable medium described herein, the request may be transmitted in a random access message, and the resource allocation may be received in a random access response that indicates an uplink resource for the uplink measurement report. In some examples of the method, UEs, and non-transitory computer-readable medium described herein, the resource allocation may be a first resource allocation of a set of multiple resource allocations configured prior to transmission of the request, and the first resource allocation is within a configured duration subsequent to transmitting the request to provide the uplink measurement report.

Some examples of the method, UEs, and non-transitory computer-readable medium described herein may further include operations, features, means, or instructions for determining at least a first uplink measurement value of at least a first uplink parameter of the one or more uplink parameters to include in the uplink measurement report in accordance with one or more of a measurement of a downlink reference signal, an offset associated with the measurement, or assistance information received from the network entity for the first uplink parameter.

In some examples of the method, UEs, and non-transitory computer-readable medium described herein, the uplink measurement report includes one or more of an uplink reference signal received power (RSRP) estimation that is in accordance with a downlink RSRP measurement of a reference signal, a nominal or maximum uplink transmit power of the UE, an offset value, a maximum permissible exposure (MPE) metric, a power headroom value, an uplink signal to interference and noise ratio (SINR), or an uplink throughput value.

Another innovative aspect of the subject matter described in this disclosure can be implemented in a method for wireless communication. The method includes transmitting, to a UE, configuration information that indicates the UE can transmit a request to provide an uplink measurement report for one or more uplink parameters associated with an uplink channel between the UE and a network entity, receiving, from the UE, the request to provide the uplink measurement report, transmitting a resource allocation to the UE for transmission of the uplink measurement report, and receiving the uplink measurement report using uplink resources indicated in the resource allocation.

Another innovative aspect of the subject matter described in this disclosure can be implemented in a network entity for wireless communication. The network entity may include one or more memories storing processor executable code, and one or more processors coupled with the one or more memories. The one or more processors may individually or collectively be operable to execute the code to cause the network entity to transmit, to a UE, configuration information that indicates the UE can transmit a request to provide an uplink measurement report for one or more uplink parameters associated with an uplink channel between the UE and a network entity, receive, from the UE, the request to provide the uplink measurement report, transmit a resource allocation to the UE for transmission of the uplink measurement report, and receive the uplink measurement report using uplink resources indicated in the resource allocation.

Another innovative aspect of the subject matter described in this disclosure can be implemented in a network entity for wireless communication. The network entity may include means for transmitting, to a UE, configuration information that indicates the UE can transmit a request to provide an uplink measurement report for one or more uplink parameters associated with an uplink channel between the UE and a network entity, means for receiving, from the UE, the request to provide the uplink measurement report, means for transmitting a resource allocation to the UE for transmission of the uplink measurement report, and means for receiving the uplink measurement report using uplink resources indicated in the resource allocation.

Another innovative aspect of the subject matter described in this disclosure can be implemented in a non-transitory computer-readable medium storing code for wireless communication. The code may include instructions executable by one or more processors to transmit, to a UE, configuration information that indicates the UE can transmit a request to provide an uplink measurement report for one or more uplink parameters associated with an uplink channel between the UE and a network entity, receive, from the UE, the request to provide the uplink measurement report, transmit a resource allocation to the UE for transmission of the uplink measurement report, and receive the uplink measurement report using uplink resources indicated in the resource allocation.

In some examples of the method, network entities, and non-transitory computer-readable medium described herein, the one or more uplink parameters include a beam pattern of an uplink beam, an uplink power backoff at the UE for uplink transmissions via one or more uplink beams, a set of available uplink antenna ports at the UE, or any combination thereof. In some examples of the method, network entities, and non-transitory computer-readable medium described herein, the request to provide the uplink measurement report may be indicated by a request field in an uplink control information transmission, a configured uplink control channel resource, one or more request bits of a downlink beam measurement report, an uplink random access channel resource, an uplink random access channel preamble, or any combination thereof.

In some examples of the method, network entities, and non-transitory computer-readable medium described herein, the configuration information indicates that the request is to be transmitted by the UE using one or more of an uplink control information transmission, a scheduling request, a random access message using a random access resource configured for transmitting the request, or a random access preamble that indicates the request. In some examples of the method, network entities, and non-transitory computer-readable medium described herein, the resource allocation may be transmitted in a downlink control information message that indicates an uplink resource for transmission of the uplink measurement report, and the downlink control information message may have a format associated with the uplink measurement report.

In some examples of the method, network entities, and non-transitory computer-readable medium described herein, the request may be received in a random access message, and the resource allocation may be transmitted in a random access response that indicates an uplink resource for the uplink measurement report. In some examples of the method, network entities, and non-transitory computer-readable medium described herein, the resource allocation may be a first resource allocation of a set of multiple resource allocations configured prior to transmission of the request, and the first resource allocation is within a configured duration subsequent to transmission of the request to provide the uplink measurement report.

In some examples of the method, network entities, and non-transitory computer-readable medium described herein, at least a first uplink measurement value of a least a first uplink parameter of the one or more uplink parameters included in the uplink measurement report is in accordance with one or more of a measurement of a downlink reference signal, an offset associated with the measurement, or assistance information provided to the UE for the first uplink parameter. In some examples of the method, network entities, and non-transitory computer-readable medium described herein, the uplink measurement report includes one or more of an uplink RSRP estimation that is in accordance with a downlink RSRP measurement of a reference signal, a nominal or maximum uplink transmit power of the UE, an offset value, a MPE metric, a power headroom value, an uplink SINR, or an uplink throughput value.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports user equipment (UE) uplink beam reporting in wireless communications in accordance with one or more aspects of the present disclosure.

FIG. 2 shows an example of a portion of a wireless communications system that supports UE uplink beam reporting in wireless communications in accordance with one or more aspects of the present disclosure.

FIG. 3 shows an example of a portion of a wireless communications system that supports UE uplink beam reporting in wireless communications in accordance with one or more aspects of the present disclosure.

FIG. 4 shows an example of a process flow that supports UE uplink beam reporting in wireless communications in accordance with one or more aspects of the present disclosure.

FIGS. 5 and 6 show block diagrams of devices that support UE uplink beam reporting in wireless communications in accordance with one or more aspects of the present disclosure.

FIG. 7 shows a block diagram of a communications manager that supports UE uplink beam reporting in wireless communications in accordance with one or more aspects of the present disclosure.

FIG. 8 shows a diagram of a system including a device that supports UE uplink beam reporting in wireless communications in accordance with one or more aspects of the present disclosure.

FIGS. 9 and 10 show block diagrams of devices that support UE uplink beam reporting in wireless communications in accordance with one or more aspects of the present disclosure.

FIG. 11 shows a block diagram of a communications manager that supports UE uplink beam reporting in wireless communications in accordance with one or more aspects of the present disclosure.

FIG. 12 shows a diagram of a system including a device that supports UE uplink beam reporting in wireless communications in accordance with one or more aspects of the present disclosure.

FIGS. 13 and 14 show flowcharts illustrating methods that support UE uplink beam reporting in wireless communications in accordance with one or more aspects of the present disclosure.

### DETAILED DESCRIPTION

In some existing wireless communications systems, a user equipment (UE) may provide one or more measurement reports that indicate channel conditions and/or measurements for signals (such as reference signals) that are received at the UE. In some cases, the measurement reports may contain one or more downlink metrics for multiple measured beams, and a network entity may select a beam for use in communications with the UE based on the reported downlink metrics. For example, a network entity (such as a base station, radio head, or transmission-reception point (TRP)) may transmit multiple reference signals using directional transmissions along multiple associated spatial paths between the network entity and the UE, which may be referred to as beams, and the UE may provide metrics associated with multiple beams in the one or more measurement reports. The network entity may select one of the beams based on the one or more measurement reports, such as by selecting a beam that has a favorable channel condition for communications, and the selected beam may be used for subsequent downlink transmissions to the UE. Further, reciprocal beamforming parameters associated with the selected beam may be used for a reciprocal uplink beam for transmissions from the UE to the network entity.

However, in some scenarios the uplink beam that corresponds to the selected downlink beam may not be optimal for uplink communications, even though the downlink beam may have favorable channel conditions for downlink communications. For example, a UE may report two downlink reference signal beams, where a first downlink beam has a higher reference signal received power (RSRP) than a second downlink beam. In some cases, a corresponding first uplink beam that is a reciprocal beam of the first downlink beam may not be as favorable as a second uplink beam that is a reciprocal beam of the second downlink beam. Such a scenario may occur, for example, if the UE performs a power backoff for one or more antenna elements associated with the first uplink beam which is not performed for the second uplink beam, such as due to maximum permissible exposure (MPE) limits. In some wireless communications systems, UEs may provide uplink beam reports in addition to downlink beam reports, which may allow a network entity to account for conditions associated with uplink communications in beam selection. However, such uplink beam reports are transmitted in accordance with a periodic schedule or in response to a trigger from a network entity. In some scenarios, more dynamic uplink reporting to the network entity may be beneficial due to changes at the UE side, such as a changed quantity of available antenna elements at the UE, a changed uplink beam pattern due to UE device management (such as thermal management), or an uplink power backoff due to MPE conditions. Existing uplink beam reporting does not provide a mechanism for such dynamic uplink reporting.

In accordance with various aspects, a UE may transmit a request for an update of an uplink beam report to provide information related to one or more changed conditions at the UE that impact uplink communications from the UE to a network entity. In some aspects, the UE may detect one or more changed conditions at the UE, such as due to a changed uplink beam pattern or uplink power backoff, and may request to update an uplink beam report or both an uplink and downlink beam report. The request may be transmitted, in some aspects, using one or more bits in an ongoing uplink transmission, using a configured physical uplink control channel (PUCCH) resource, using one or more configured bits of a downlink beam report, using a dedicated uplink resource, or any combination thereof. The network entity may receive the request, and may trigger an uplink beam report transmission. In some aspects, the UE may transmit a capability indication to the network entity that indicates a UE capability to request an updated uplink beam report, and the network entity may configure, such as by radio resource control (RRC) signaling, one or more uplink communications to include one or more bits to indicate the request, one or more uplink resources to transmit the request, or one or more random access messages that indicate the request. In some examples, the network entity may configure an uplink control information (UCI) type, a scheduling request (SR), or physical random access channel (PRACH) preamble that indicates the request from the UE. In some aspects, the network entity may receive the request from the UE, and transmit a downlink signal to the UE that indicates a resource for transmission of the uplink beam report from the UE. In some aspects, for uplink channel estimation, the UE may measure a downlink reference signal and apply an offset to estimate an associated uplink metric, may use assistance information provided by the network entity, or may derive an uplink metric based on an estimated pathloss of a channel and a configured uplink transmit power.

Particular aspects of the subject matter described in this disclosure may be implemented to realize one or more of the following potential advantages. The techniques employed by the described communication devices may provide benefits and enhancements to the operation of the communication devices, including enhanced uplink communication reliability and data rates. For example, operations performed by the described communication devices may provide improvements to uplink beam selection by reporting of changed uplink conditions at a transmitting device that are used to select a favorable uplink beam. In some implementations, the operations performed by the described communication devices to provide uplink beam reports based on changed conditions may reduce a time duration for updating uplink communications parameters to account for the changed conditions, thereby reducing the probability of a communications failure for uplink communications. In some other implementations, operations performed by the described communication devices may also support improvements to power consumption, reliability for uplink communications, spectral efficiency, higher data rates and, in some examples, low latency for uplink communications, among other benefits.

Aspects of the disclosure are initially described in the context of wireless communications systems. Aspects of the disclosure are further illustrated by and described with reference to a process flow, apparatus diagrams, system diagrams, and flowcharts that relate to UE uplink beam reporting in wireless communications.

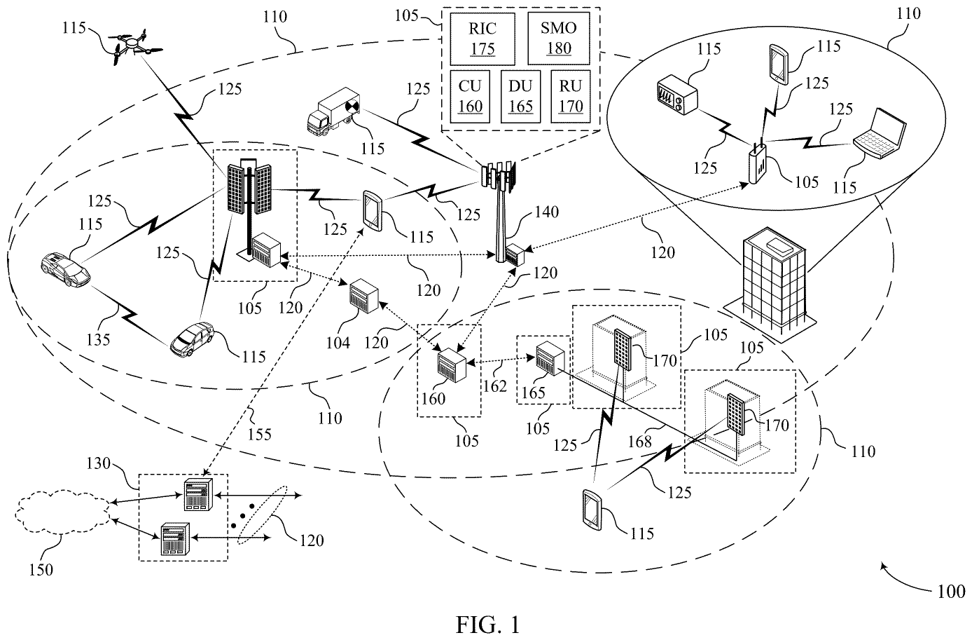

FIG. 1 shows an example of a wireless communications system 100 that supports UE uplink beam reporting in wireless communications in accordance with one or more aspects of the present disclosure. The wireless communications system 100 may include one or more devices, such as one or more network devices (for example, network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (for example, a radio frequency (RF) access link). For example, a network entity 105 may support a coverage area 110 (for example, a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (for example, other wireless communication devices, including UEs 115 or network entities 105), as shown in FIG. 1.

As described herein, a node of the wireless communications system 100, which may be referred to as a network node, or a wireless node, may be a network entity 105 (for example, any network entity described herein), a UE 115 (for example, any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (for example, in accordance with an S1, N2, N3, or other interface protocol). In some examples, network entities 105 may communicate with one another via backhaul communication link(s) 120 (for example, in accordance with an X2, Xn, or other interface protocol) either directly (for example, directly between network entities 105) or indirectly (for example, via the core network 130). In some examples, network entities 105 may communicate with one another via a midhaul communication link 162 (for example, in accordance with a midhaul interface protocol) or a fronthaul communication link 168 (for example, in accordance with a fronthaul interface protocol), or any combination thereof. The backhaul communication link(s) 120, midhaul communication links 162, or fronthaul communication links 168 may be or include one or more wired links (for example, an electrical link, an optical fiber link) or one or more wireless links (for example, a radio link, a wireless optical link), among other examples or various combinations thereof. A UE 115 may communicate with the core network 130 via a communication link 155.

One or more of the network entities 105 or network equipment described herein may include or may be referred to as a base station 140 (for example, a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (for example, a base station 140) may be implemented in an aggregated (for example, monolithic, standalone) base station architecture, which may be configured to utilize a protocol stack that is physically or logically integrated within one network entity (for example, a network entity 105 or a single RAN node, such as a base station 140).

In some examples, a network entity 105 may be implemented in a disaggregated architecture (for example, a disaggregated base station architecture, a disaggregated RAN architecture), which may be configured to utilize a protocol stack that is physically or logically distributed among multiple network entities (for example, network entities 105), such as an integrated access and backhaul (IAB) network, an open RAN (O-RAN) (for example, a network configuration sponsored by the O-RAN Alliance), or a virtualized RAN (vRAN) (for example, a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (for example, a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (for example, separate physical locations). In some examples, one or more of the network entities 105 of a disaggregated RAN architecture may be implemented as virtual units (for example, a virtual CU (VCU), a virtual DU (VDU), a virtual RU (VRU)).

The split of functionality between a CU 160, a DU 165, and an RU 170 is flexible and may support different functionalities depending on which functions (for example, network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (for example, layer 3(L3 ), layer 2 (L2)) functionality and signaling (for example, Radio Resource Control (RRC), service data adaptation protocol (SDAP), Packet Data Convergence Protocol (PDCP)). The CU 160 (for example, one or more CUs) may be connected to a DU 165 (for example, one or more DUs) or an RU 170 (for example, one or more RUs), or some combination thereof, and the DUs 165, RUs 170, or both may host lower protocol layers, such as layer 1 (L1 ) (for example, physical (PHY) layer) or L2 (for example, radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (for example, via one or multiple different RUs, such as an RU 170). In some cases, a functional split between a CU 160 and a DU 165 or between a DU 165 and an RU 170 may be within a protocol layer (for example, some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (for example, F1, F1-c, F1-u), and a DU 165 may be connected to an RU 170 via a fronthaul communication link 168 (for example, open fronthaul (FH) interface). In some examples, a midhaul communication link 162 or a fronthaul communication link 168 may be implemented in accordance with an interface (for example, a channel) between layers of a protocol stack supported by respective network entities (for example, one or more of the network entities 105) that are in communication via such communication links.

In some wireless communications systems (for example, the wireless communications system 100), infrastructure and spectral resources for radio access may support wireless backhaul link capabilities to supplement wired backhaul connections, providing an IAB network architecture (for example, to a core network 130). In some cases, in an IAB network, one or more of the network entities 105 (for example, network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (for example, IAB donors) may be in communication with one or more additional devices (for example, IAB node(s) 104) via supported access and backhaul links (for example, backhaul communication link(s) 120). IAB node(s) 104 may include an IAB mobile termination (IAB-MT) controlled (for example, scheduled) by one or more DUs (for example, DUs 165) of a coupled IAB donor. An IAB-MT may be equipped with an independent set of antennas for relay of communications with UEs 115 or may share the same antennas (for example, of an RU 170) of IAB node(s) 104 used for access via the DU 165 of the IAB node(s) 104 (for example, referred to as virtual IAB-MT (vIAB-MT)). In some examples, the IAB node(s) 104 may include one or more DUs (for example, DUs 165) that support communication links with additional entities (for example, IAB node(s) 104, UEs 115) within the relay chain or configuration of the access network (for example, downstream). In such cases, one or more components of the disaggregated RAN architecture (for example, the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support UE uplink beam reporting in wireless communications as described herein. For example, some operations described as being performed by a UE 115 or a network entity 105 (for example, a base station 140) may additionally, or alternatively, be performed by one or more components of the disaggregated RAN architecture (for example, components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (for example, one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (for example, a bandwidth part (BWP)) that is operated according to one or more PHY layer channels for a given RAT (for example, LTE, LTE-A, LTE-A Pro, NR). Each PHY layer channel may carry acquisition signaling (for example, synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (for example, entity, sub-entity) of a network entity 105. For example, the terms “transmitting,” “receiving,” or “communicating,” when referring to a network entity 105, may refer to any portion of a network entity 105 (for example, a base station 140, a CU 160, a DU 165, a RU 170) of a RAN communicating with another device (for example, directly or via one or more other network entities, such as one or more of the network entities 105).

Signal waveforms transmitted via a carrier may be made up of multiple subcarriers (for example, using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (for example, a duration of one modulation symbol) and one subcarrier, in which case the symbol period and subcarrier spacing may be inversely related. The quantity of bits carried by each resource element may depend on the modulation scheme (for example, the order of the modulation scheme, the coding rate of the modulation scheme, or both), such that a relatively higher quantity of resource elements (for example, in a transmission duration) and a relatively higher order of a modulation scheme may correspond to a relatively higher rate of communication. A wireless communications resource may refer to a combination of an RF spectrum resource, a time resource, and a spatial resource (for example, a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (for example, 10 milliseconds (ms)). Each radio frame may be identified by a system frame number (SFN) (for example, ranging from 0 to 1023).

Each frame may include multiple consecutively-numbered subframes or slots, and each subframe or slot may have the same duration. In some examples, a frame may be divided (for example, in the time domain) into subframes, and each subframe may be further divided into a quantity of slots. Alternatively, each frame may include a variable quantity of slots, and the quantity of slots may depend on subcarrier spacing. Each slot may include a quantity of symbol periods (for example, depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (for example, N_{f}) sampling periods. The duration of a symbol period may depend on the subcarrier spacing or frequency band of operation.

A subframe, a slot, a mini-slot, or a symbol may be the smallest scheduling unit (for example, in the time domain) of the wireless communications system 100 and may be referred to as a transmission time interval (TTI). In some examples, the TTI duration (for example, a quantity of symbol periods in a TTI) may be variable. Additionally, or alternatively, the smallest scheduling unit of the wireless communications system 100 may be dynamically selected (for example, in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (for example, a control resource set (CORESET)) for a physical control channel may be defined by a set of symbol periods and may extend across the system bandwidth or a subset of the system bandwidth of the carrier. One or more control regions (for example, CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (for example, control channel elements (CCEs)) associated with encoded information for a control information format having a given payload size. Search space sets may include common search space sets configured for sending control information to UEs 115 (for example, one or more UEs) or may include UE-specific search space sets for sending control information to a UE 115 (for example, a specific UE).

In some examples, a network entity 105 (for example, a base station 140, an RU 170) may be movable and therefore provide communication coverage for a moving coverage area, such as the coverage area 110. In some examples, coverage areas 110 (for example, different coverage areas) associated with different technologies may overlap, but the coverage areas 110 (for example, different coverage areas) may be supported by the same network entity (for example, a network entity 105). In some other examples, overlapping coverage areas, such as a coverage area 110, associated with different technologies may be supported by different network entities (for example, the network entities 105). The wireless communications system 100 may include, for example, a heterogeneous network in which different types of the network entities 105 support communications for coverage areas 110 (for example, different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (for example, one or more of the UEs 115) via a device-to-device (D2D) communication link, such as a D2D communication link 135 (for example, in accordance with a peer-to-peer (P2P), D2D, or sidelink protocol). In some examples, one or more UEs 115 of a group that are performing D2D communications may be within the coverage area 110 of a network entity 105 (for example, a base station 140, an RU 170), which may support aspects of such D2D communications being configured by (for example, scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (for example, a mobility management entity (MME), an access and mobility management function (AMF)) and at least one user plane entity that routes packets or interconnects to external networks (for example, a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (for example, base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (for example, less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (for example, LAA). Operations using unlicensed spectrum may include downlink transmissions, uplink transmissions, P2P transmissions, or D2D transmissions, among other examples.

A network entity 105 (for example, a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (for example, a network entity 105, a UE 115) to shape or steer an antenna beam (for example, a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (for example, with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some aspects, one or more UEs 115 may provide measurement reports, or beam reports, that indicate measurements of downlink reference signals, which may be used for beam selection for subsequent communications. In some implementations, in addition to measurements associated with downlink reference signals, one or more beam reports may include one or more parameters associated with uplink beams from a UE 115. In some aspects, one or more UEs 115 may detect a changed condition associated with uplink communications, and may transmit a request for an update of a beam report to provide one or more uplink parameters. In some implementations, such a UE 115 may detect one or more changed conditions, such as due to a changed uplink beam pattern or uplink power backoff, and may request to update an uplink beam report or both an uplink and downlink beam report. A network entity 105 may receive the request, and transmit an indication to the UE 115 of an uplink resource for transmission of the uplink beam report, and the UE 115 may transmit the uplink beam report using the indicated uplink resource.

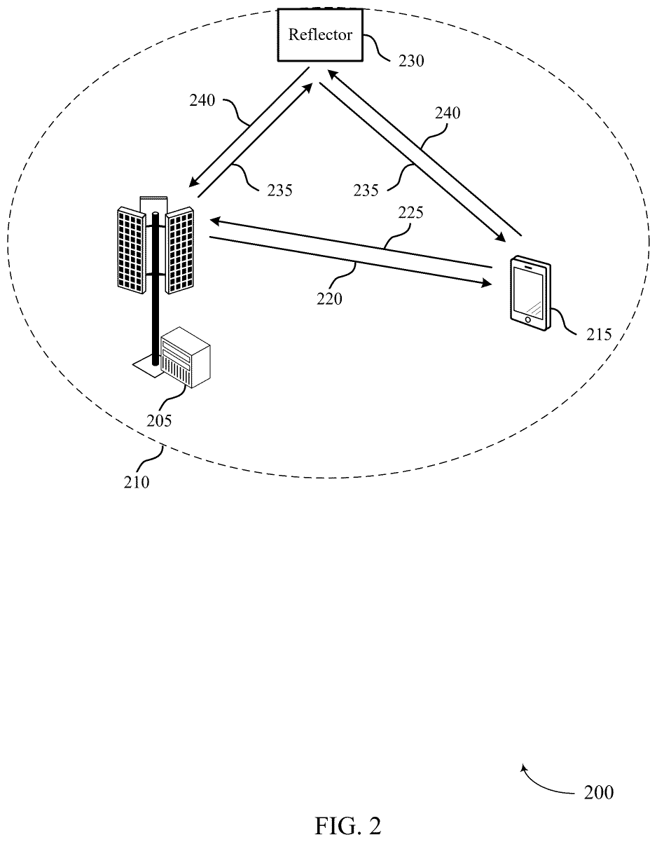

FIG. 2 shows an example of a portion of a wireless communications system 200 that supports UE uplink beam reporting in wireless communications in accordance with one or more aspects of the present disclosure. The wireless communications system 200 may include a UE 215, and a network entity 205 with coverage area 210, which may be examples of a UE 115 and a network entity 105, as described with reference to FIG. 1.

In the wireless communications system 200 of FIG. 2, the UE 215 and the network entity 205 may have multiple beams available for communications, including a first beam that corresponds to a line of sight path between the UE 215 and the network entity 205 and that supports a first downlink communication link 220 and a first uplink communication link 225. The multiple beams also may include a second beam that corresponds to a non-line-of-sight path via a reflector 230, and that supports a second downlink communication link 235 and a second uplink communication link 240. The UE 215 may measure one or more parameters associated with each beam, and in some examples may measure a first RSRP associated with the first downlink communication link 220 that is higher than a second RSRP associated with the second downlink communication link 235. The UE 215 may provide a measurement report that indicates the measured RSRP values, and the network entity 205 may select the first beam, and the first downlink communication link 220 and the first uplink communication link 225, for communications between the network entity 205 and the UE 215.

As discussed herein, in some aspects the UE 215 also may provide one or more uplink parameters in a measurement report, such as an uplink measurement report that is separate from a downlink measurement report, or a combined measurement report that includes both downlink and uplink parameters. In some aspects, the UE 215 may determine that one or more uplink parameters have changed since a prior measurement report that provides uplink parameters. For example, an MPE change at the UE 215 may result in a lower available uplink transmit power for the first uplink communication link 225, but not for the second uplink communication link 240 (such as due to different antennas associated with the different links). In accordance with various aspects, the UE 215 may transmit a request for an update of an uplink beam report to provide information related to the one or more changed conditions at the UE 215. In some aspects, the UE 215 may request to update an uplink beam report or both an uplink and downlink beam report. The request may be transmitted, in some aspects, using one or more bits in an ongoing uplink transmission, using a configured PUCCH resource, using one or more configured bits of a downlink beam report that is transmitted to the network entity 205, using a dedicated uplink resource, or any combination thereof. The network entity 205 may receive the request, and may trigger an uplink beam report transmission. The UE 215 may transmit a measurement report with one or more uplink parameters, which may be used by the network entity 205 to select a same or a different beam for uplink and/or downlink communications. In some implementations, the UE 215 may measure downlink reference signals on each of the first downlink communication link 220 and the second downlink communication link 235, which may correspond to two narrow channel state information (CSI) reference signal beams that are quasi-co-located (QCLed) with a same SSB beam or two different SSB beams.

In some aspects, the UE 215 may transmit a capability indication to the network entity 205 that indicates a UE 215 capability to request an updated uplink beam report, and the network entity 205 may configure, such as by RRC signaling, the UE 215 to transmit the request and associated uplink beam report. In some aspects, the UE 215 may transmit a joint uplink and downlink beam report, and may report a top N downlink and uplink beams, respectively, and the network entity may select beams for subsequent communications based on the report. In some aspects, to reduce overhead, the UE 215 may report N beams with both downlink and uplink metrics per reported beam. Further, in some aspects beam metrics may be provided in a cell report for lower layer triggered mobility, where both downlink and uplink beam metrics can be reported per reported candidate cell.

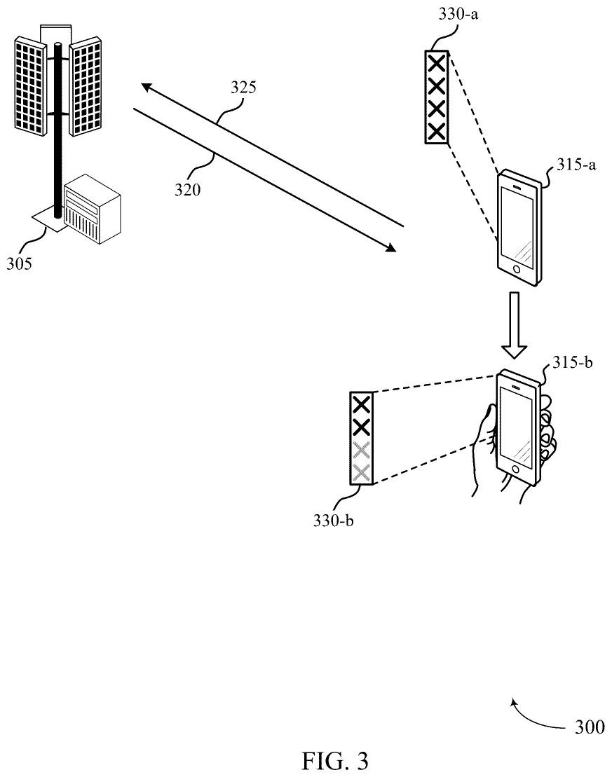

As discussed herein, in some aspects the UE 215 may transmit a request to provide an updated uplink beam report. Such a request may be transmitted based on one or more conditions that are present at the UE 215, and that the network entity 205 may not be aware of such conditions at the UE 215. For example, the conditions at the UE 215 may include an uplink beam pattern that is changed due to fewer antenna elements that are available per uplink port at the UE 215 (such as illustrated in FIG. 3). Additionally, or alternatively, the conditions at the UE 215 may include an uplink beam pattern associated with a transmission configuration indicator (TCI) that is dynamically updated at the UE 215 due to device management (such as thermal management or power management at the UE 215). Additionally, or alternatively, the conditions at the UE 215 may include an uplink power backoff (such as due to MPE) that occurred but did not trigger a separate MPE report.

In some implementations, the request from the UE 215 may be provided in a single bit indicator to indicate whether an update of an uplink beam report is requested, where the indicator may be included in an ongoing uplink transmission. In some other implementations, the request from the UE 215 may be provided in a dedicated PUCCH resource that is configured for requesting for resources for an updated uplink report (such as a one or multi-bit PUCCH resource that indicates the request). In further implementations, the request from the UE 215 may be provided using one or more bits of a downlink beam report that is transmitted by the UE 215 (such as a reserved bit in a periodic, semi-persistent, or aperiodic downlink beam report). In still further implementations, the request from the UE 215 may be provided using a dedicated uplink resource, such as a resource that is configured by RRC. In some aspects, one or more of these techniques may be available for the UE 215 to transmit the request. The network entity 205 may trigger an uplink beam report based on the request.

In some aspects, depending on a UE 215 capability, the network entity 205 may configure the UE 215 with an uplink resource configuration to send the request. In some implementations, the request may be indicated in an uplink control information (UCI) message (such as by using a UCI type that is associated with a request for an updated uplink beam report), the request may be indicated in a scheduling request (such as a scheduling request having a format that indicates the request), in a dedicated PRACH preamble (such as a configured preamble that indicates the request), or any combination thereof. The network entity 205, upon receiving the request, may transmit a downlink signal to indicate a resource for the UE 215 to transmit the updated uplink beam report. In some implementations, the downlink signal may use an existing downlink control information (DCI) format, or may use a DCI format that is defined for transmission of such a request. Additionally, or alternatively, the network entity 205 may configure periodic resources (such as in a configured grant of periodic resources) that may be used to transmit the uplink beam report. In some implementations, the UE 215 may transmit the request, and may transmit the uplink beam report using one of the configured uplink resources that is within a configured time duration from the transmission of the request (such as within X symbols after sending the request).

In some aspects, one or more parameters included in the uplink beam report may be determined by the UE 215 based on one or more downlink reference signal measurements. In some implementations, for an uplink RSRP estimation, the UE 215 may use a downlink reference signal measurement corresponding to the beam to first get the downlink RSRP and then derive an associated uplink RSRP. In some implementations, the downlink reference signal may be a QCLed reference signal in the TCI of the uplink beam. In some aspects, the network entity 205 may provide assistance information that may be used by the UE 215 to estimate one or more uplink parameters. For example, the UE 215 may derive an uplink RSRP based on an uplink configured transmit power minus a measured downlink RSRP, plus an offset value provided by the network entity 205 (that is, UL RSRP=UL configured Tx Power−DL RSRP+offset). The offset may be configured by the network entity 205 to compensate for a higher downlink transmit power relative to an uplink transmit power. In some implementations, the UE 215 may estimate a pathloss and derive an uplink RSRP based on the pathloss. For example, a pathloss reference signal (such as a CSI reference signal) corresponding to an uplink reference signal may be used to estimate a downlink pathloss, and the downlink pathloss may be used to derive the uplink RSRP (that is, UL RSRP=UL configured Tx Power−pathloss). In some implementations, the measurement report from the UE 215 may include downlink metrics, such as downlink RSRP for the same reference signal, or a different set of downlink reference signals configured for a downlink report.

FIG. 3 shows an example of a portion of a wireless communications system 300 that supports UE uplink beam reporting in wireless communications in accordance with one or more aspects of the present disclosure. The wireless communications system 300 may include a UE 315, and a network entity 305, which may be examples of UEs and network entities as described with reference to FIGS. 1 and 2.

In the wireless communications system 300 of FIG. 3, the UE 315 and the network entity 305 may have multiple beams available for communications, including a first beam as illustrated in FIG. 3 that supports a first downlink communication link 320 and a first uplink communication link 325. In this example, an initial condition shown as UE 315-a may provide that a set of antennas 330-a of the UE 315-a has all available antenna elements usable for communications. The UE 315-a may have transmitted an uplink beam report based on the initial state, that indicates uplink beam parameters associated with the initial state of UE 315-a and the set of antennas 330-a. Subsequent to the initial condition, a user may place their hand such that one or more of the antenna elements may not be usable for communications, shown as UE 315-b where the set of antennas 330-b include fewer available antenna elements. In some implementations, based on a detection of the new condition, the UE 315 may transmit a request for an updated uplink beam report, in order to provide updated uplink beam parameters associated with updated state of UE 315-b and the set of antennas 330-b with fewer available antenna elements. The network entity 305 may receive the request, and provide an indication of resources for the updated beam report, receive the updated beam report, and select an uplink and/or downlink beam based on the updated beam report, as discussed herein.

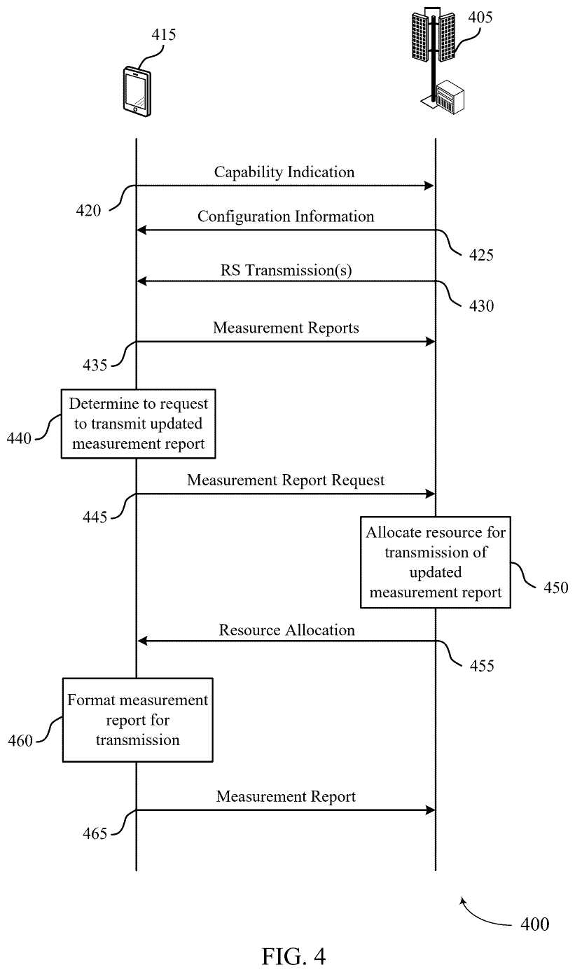

FIG. 4 shows an example of a process flow 400 that supports UE uplink beam reporting in wireless communications in accordance with one or more aspects of the present disclosure. The process flow 400 may include a network entity 405 and a UE 415, which may be examples of corresponding devices as described with reference to FIGS. 1 through 3. The UE 415 may perform uplink beam reporting and the UE 415 and network entity 405 may perform updates to uplink beam reporting as discussed herein. Such techniques may provide for enhanced communication reliability, reduced latency, and efficient communications, which may thereby enhance overall network efficiency and user experience. In the following description of the process flow 400, the operations between the devices may be performed in a different order than the example order shown. Some operations may be omitted from the process flow 400, and other operations may be added to the process flow 400.

At 420, the UE 415 may transmit, and the network entity 405 may receive, a capability indication that indicates a UE 415 capability to request an uplink beam report. The capability indication may indicate, in some implementations, that the UE 415 is capable of transmitting a request for an uplink beam report update. In some implementations, the capability indication may indicate additional capabilities, such as a capability to derive uplink metrics based on assistance information from the network entity 405 or a capability to compute an estimated pathloss for use in deriving an associated uplink parameter, and the network entity 405 may provide assistance information or a configuration based on the indicated capability.

At 425, the network entity 405 may transmit, and the UE 415 may receive, configuration information related to uplink beam report requests and associated resources. In some implementations, the configuration information may be provided via RRC signaling. Additionally, or alternatively, all or a portion of the configuration information may be provided in a medium access control (MAC) control element, or in downlink control information.

At 430, the network entity 405 may transmit, and the UE 415 may receive, one or more reference signal transmissions. In some implementations, the reference signal transmissions may include CSI reference signal transmissions, synchronization signal block (SSB) transmissions, or other reference signal transmissions (such as pathloss reference signals other downlink reference signals). At 435, the UE 415 may transmit, and the network entity 405 may receive, one or more measurement reports. The measurement reports may include, in some implementations, downlink measurement reports, uplink measurement reports, and/or joint uplink and downlink measurement reports.

At 440, the UE 415 may determine to request to transmit an updated measurement report. The UE 415 may make the determination based on one or more conditions at the UE 415, such as a changed power backoff or MPE limitation, as discussed herein. At 445, the UE 415 may transmit, and the network entity 405 may receive, a measurement report request. In some implementations, as discussed herein, the measurement report request may be a single or multi-bit indication that is provided in UCI, in a downlink beam report, in a configured uplink resource, a configured PRACH preamble, or any combination thereof.

At 450, the network entity may allocate a resource for transmission of an updated measurement report. At 455, the network entity 405 may transmit, and the UE 415 may receive, a resource allocation for the uplink beam report. In some implementations, the resource allocation may be made based on receipt of the request. In other implementations, the resource allocation may be provided to the UE 415 along with the configuration information, such as in a configured grant of uplink resources, and the UE 415 may use one of the configured resources after transmission of the request.

At 460, the UE 415 may format the uplink measurement report for transmission. The measurement report, as discussed herein, may be an uplink beam report that includes one or more uplink parameters that are measured or derived by the UE 415. At 465, the UE 415 may transmit, and the network entity 405 may receive, the updated uplink beam report. In some implementations, a downlink measurement report may also be formatted and transmitted, or a joint uplink and downlink measurement report may be formatted and transmitted.

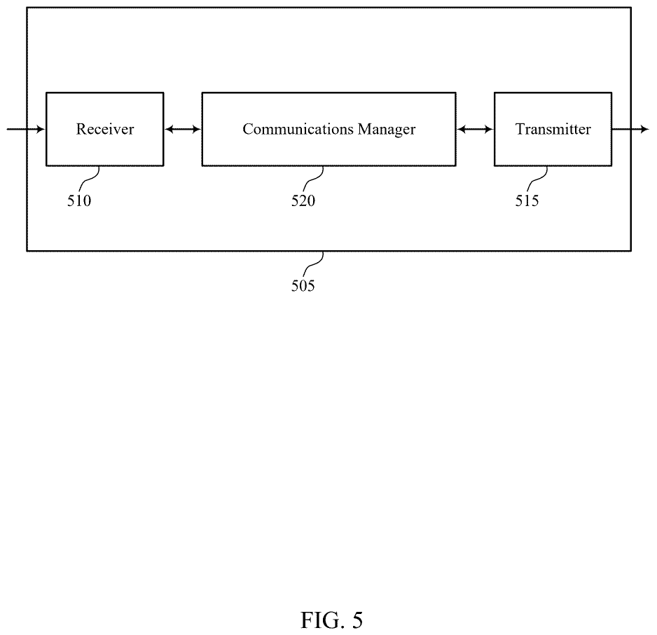

FIG. 5 shows a block diagram of a device 505 that supports UE uplink beam reporting in wireless communications in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (for example, the receiver 510, the transmitter 515, the communications manager 520), may include at least one processor, which may be coupled with at least one memory, to, individually or collectively, support or enable the described techniques. Each of these components may be in communication with one another (for example, via one or more buses).

The receiver 510 may provide a means for receiving information such as packets, user data, control information, or any combination thereof associated with various information channels (for example, control channels, data channels, information channels related to UE uplink beam reporting in wireless communications). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (for example, control channels, data channels, information channels related to UE uplink beam reporting in wireless communications). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of UE uplink beam reporting in wireless communications as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (for example, in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (for example, by one or more processors, individually or collectively, executing instructions stored in the at least one memory).

Additionally, or alternatively, the communications manager 520, the receiver 510, the transmitter 515, or various combinations or components thereof may be implemented in code (for example, as communications management software or firmware) executed by at least one processor (for example, referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (for example, configured as or otherwise supporting, individually or collectively, a means for performing the functions described in the present disclosure).

In some examples, the communications manager 520 may be configured to perform various operations (for example, receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving configuration information that indicates the UE can transmit a request to provide an uplink measurement report for one or more uplink parameters associated with an uplink channel between the UE and a network entity. The communications manager 520 is capable of, configured to, or operable to support a means for transmitting the request to provide the uplink measurement report in accordance with a change in at least one of the one or more uplink parameters relative to a prior uplink measurement report. The communications manager 520 is capable of, configured to, or operable to support a means for receiving a resource allocation for transmission of the uplink measurement report. The communications manager 520 is capable of, configured to, or operable to support a means for transmitting the uplink measurement report using uplink resources indicated in the resource allocation.

By including or configuring the communications manager 520 in accordance with examples as described herein, the device 505 (for example, at least one processor controlling or otherwise coupled with the receiver 510, the transmitter 515, the communications manager 520, or a combination thereof) may support techniques for UE uplink beam reporting as discussed herein, which may enhance communications reliability and provide for reduced latency.

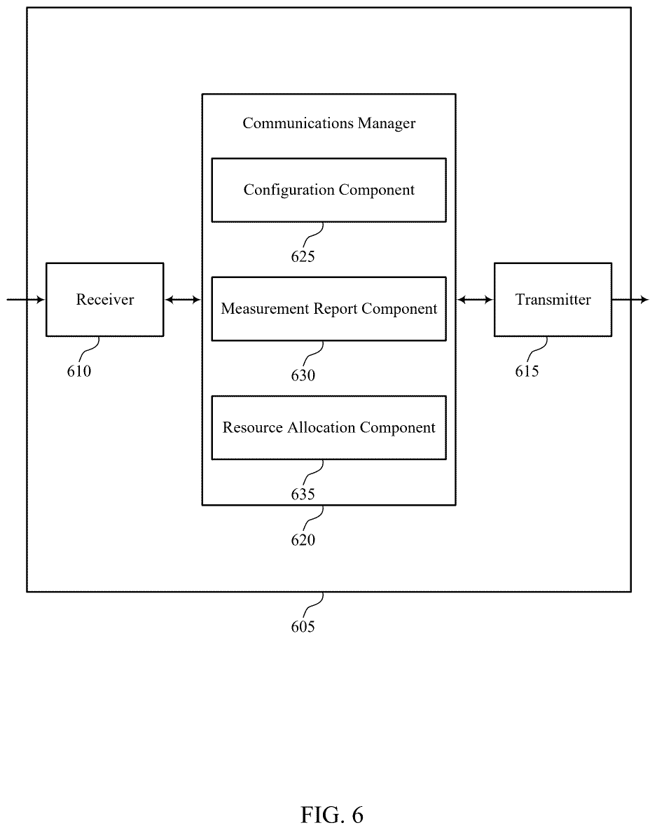

FIG. 6 shows a block diagram of a device 605 that supports UE uplink beam reporting in wireless communications in accordance with one or more aspects of the present disclosure. The device 605 may be an example of aspects of a device 505 or a UE 115 as described herein. The device 605 may include a receiver 610, a transmitter 615, and a communications manager 620. The device 605, or one of more components of the device 605 (for example, the receiver 610, the transmitter 615, the communications manager 620), may include at least one processor, which may be coupled with at least one memory, to support the described techniques. Each of these components may be in communication with one another (for example, via one or more buses).

The receiver 610 may provide a means for receiving information such as packets, user data, control information, or any combination thereof associated with various information channels (for example, control channels, data channels, information channels related to UE uplink beam reporting in wireless communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (for example, control channels, data channels, information channels related to UE uplink beam reporting in wireless communications). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of UE uplink beam reporting in wireless communications as described herein. For example, the communications manager 620 may include a configuration component 625, a measurement report component 630, a resource allocation component 635, or any combination thereof. The communications manager 620 may be an example of aspects of a communications manager 520 as described herein. In some examples, the communications manager 620, or various components thereof, may be configured to perform various operations (for example, receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The configuration component 625 is capable of, configured to, or operable to support a means for receiving configuration information that indicates the UE can transmit a request to provide an uplink measurement report for one or more uplink parameters associated with an uplink channel between the UE and a network entity. The measurement report component 630 is capable of, configured to, or operable to support a means for transmitting the request to provide the uplink measurement report in accordance with a change in at least one of the one or more uplink parameters relative to a prior uplink measurement report. The resource allocation component 635 is capable of, configured to, or operable to support a means for receiving a resource allocation for transmission of the uplink measurement report. The measurement report component 630 is capable of, configured to, or operable to support a means for transmitting the uplink measurement report using uplink resources indicated in the resource allocation.

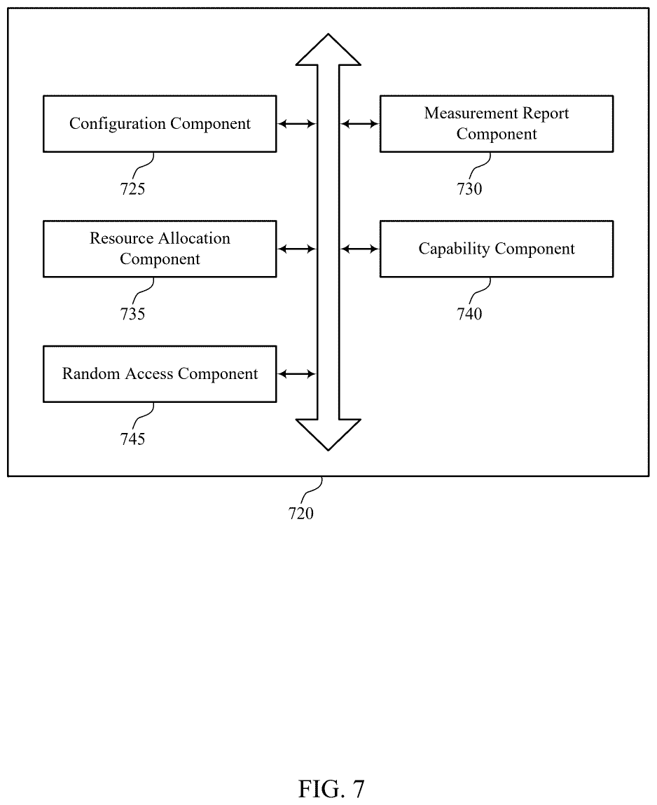

FIG. 7 shows a block diagram of a communications manager 720 that supports UE uplink beam reporting in wireless communications in accordance with one or more aspects of the present disclosure. The communications manager 720 may be an example of aspects of a communications manager 520, a communications manager 620, or both, as described herein. The communications manager 720, or various components thereof, may be an example of means for performing various aspects of UE uplink beam reporting in wireless communications as described herein. For example, the communications manager 720 may include a configuration component 725, a measurement report component 730, a resource allocation component 735, a capability component 740, a random access component 745, or any combination thereof. Each of these components, or components or subcomponents thereof (for example, one or more processors, one or more memories), may communicate, directly or indirectly, with one another (for example, via one or more buses).

The communications manager 720 may support wireless communications in accordance with examples as disclosed herein. The configuration component 725 is capable of, configured to, or operable to support a means for receiving configuration information that indicates the UE can transmit a request to provide an uplink measurement report for one or more uplink parameters associated with an uplink channel between the UE and a network entity. The measurement report component 730 is capable of, configured to, or operable to support a means for transmitting the request to provide the uplink measurement report in accordance with a change in at least one of the one or more uplink parameters relative to a prior uplink measurement report. The resource allocation component 735 is capable of, configured to, or operable to support a means for receiving a resource allocation for transmission of the uplink measurement report. In some examples, the measurement report component 730 is capable of, configured to, or operable to support a means for transmitting the uplink measurement report using uplink resources indicated in the resource allocation.

In some examples, the one or more uplink parameters include a beam pattern of an uplink beam, an uplink power backoff at the UE for uplink transmissions via one or more uplink beams, a set of available uplink antenna ports at the UE, or any combination thereof.

In some examples, the request to provide the uplink measurement report indicates a request to provide both the uplink measurement report and a downlink measurement report.

In some examples, the request to provide the uplink measurement report is indicated by a request field in an uplink control information transmission, a configured uplink control channel resource, one or more request bits of a downlink beam measurement report, an uplink random access channel resource, an uplink random access channel preamble, or any combination thereof.

In some examples, the capability component 740 is capable of, configured to, or operable to support a means for transmitting a capability indication that indicates a UE capability to request to transmit the uplink measurement report.

In some examples, the configuration information indicates that the request is to be transmitted using one or more of an uplink control information transmission, a scheduling request, a random access message using a random access resource configured for transmitting the request, or a random access preamble that indicates the request.

In some examples, the resource allocation is received in a downlink control information message that indicates an uplink resource for transmission of the uplink measurement report, and the downlink control information message has a format associated with the uplink measurement report.

In some examples, the request is transmitted in a random access message, and the resource allocation is received in a random access response that indicates an uplink resource for the uplink measurement report.

In some examples, the resource allocation is a first resource allocation of a set of multiple resource allocations configured prior to transmission of the request, and the first resource allocation is within a configured duration subsequent to transmitting the request to provide the uplink measurement report.

In some examples, the measurement report component 730 is capable of, configured to, or operable to support a means for determining at least a first uplink measurement value of at least a first uplink parameter of the one or more uplink parameters to include in the uplink measurement report in accordance with one or more of a measurement of a downlink reference signal, an offset associated with the measurement, or assistance information received from the network entity for the first uplink parameter.

In some examples, the uplink measurement report includes one or more of an uplink reference signal received power (RSRP) estimation that is in accordance with a downlink RSRP measurement of a reference signal, a nominal or maximum uplink transmit power of the UE, an offset value, a maximum permissible exposure (MPE) metric, a power headroom value, an uplink signal to interference and noise ratio (SINR), or an uplink throughput value.

In some examples, the uplink measurement report includes an uplink reference signal received power (RSRP) estimation that is in accordance with a downlink pathloss estimate derived from a downlink reference signal and an uplink transmit power of the UE.

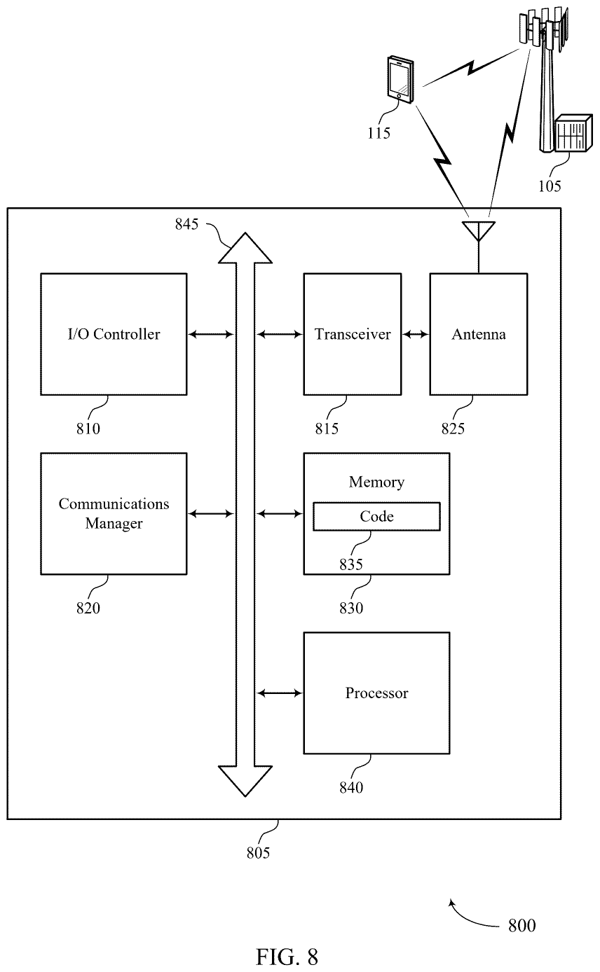

FIG. 8 shows a diagram of a system 800 including a device 805 that supports UE uplink beam reporting in wireless communications in accordance with one or more aspects of the present disclosure. The device 805 may be an example of or include components of a device 505, a device 605, or a UE 115 as described herein. The device 805 may communicate (for example, wirelessly) with one or more other devices (for example, network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (for example, operatively, communicatively, functionally, electronically, electrically) via one or more buses (for example, a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (for example, when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (for example, one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (for example, the at least one memory 830) to cause the device 805 to perform various functions (for example, functions or tasks supporting UE uplink beam reporting in wireless communications). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (for example, processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving configuration information that indicates the UE can transmit a request to provide an uplink measurement report for one or more uplink parameters associated with an uplink channel between the UE and a network entity. The communications manager 820 is capable of, configured to, or operable to support a means for transmitting the request to provide the uplink measurement report in accordance with a change in at least one of the one or more uplink parameters relative to a prior uplink measurement report. The communications manager 820 is capable of, configured to, or operable to support a means for receiving a resource allocation for transmission of the uplink measurement report. The communications manager 820 is capable of, configured to, or operable to support a means for transmitting the uplink measurement report using uplink resources indicated in the resource allocation.

By including or configuring the communications manager 820 in accordance with examples as described herein, the device 805 may support techniques for UE uplink beam reporting as discussed herein, which may enhance communications reliability and provide for reduced latency.

In some examples, the communications manager 820 may be configured to perform various operations (for example, receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of UE uplink beam reporting in wireless communications as described herein, or the at least one processor 840 and the at least one memory 830 may be otherwise configured to, individually or collectively, perform or support such operations.

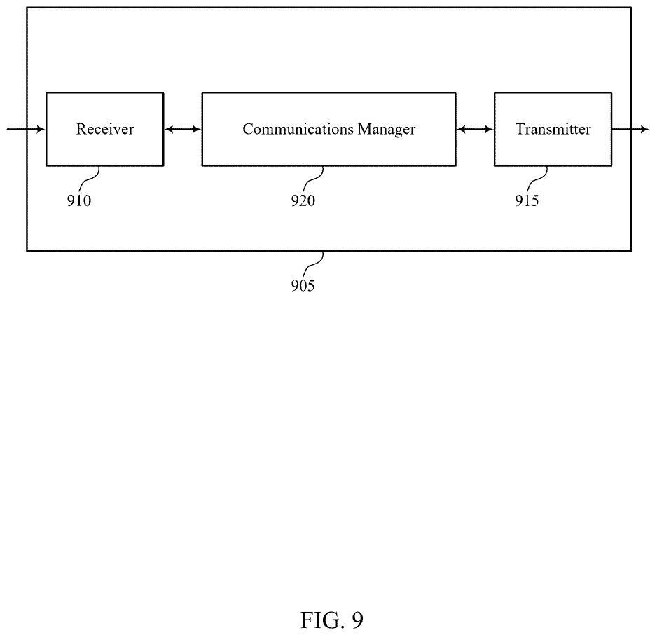

FIG. 9 shows a block diagram of a device 905 that supports UE uplink beam reporting in wireless communications in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (for example, the receiver 910, the transmitter 915, the communications manager 920), may include at least one processor, which may be coupled with at least one memory, to, individually or collectively, support or enable the described techniques. Each of these components may be in communication with one another (for example, via one or more buses).

The receiver 910 may provide a means for obtaining (for example, receiving, determining, identifying) information such as user data, control information, or any combination thereof (for example, I/Q samples, symbols, packets, protocol data units, service data units) associated with various channels (for example, control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (for example, electrical, fiber optic) interfaces, wireless interfaces, or any combination thereof.

The transmitter 915 may provide a means for outputting (for example, transmitting, providing, conveying, sending) information generated by other components of the device 905. For example, the transmitter 915 may output information such as user data, control information, or any combination thereof (for example, I/Q samples, symbols, packets, protocol data units, service data units) associated with various channels (for example, control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (for example, electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of UE uplink beam reporting in wireless communications as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (for example, in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (for example, by one or more processors, individually or collectively, executing instructions stored in the at least one memory).

Additionally, or alternatively, the communications manager 920, the receiver 910, the transmitter 915, or various combinations or components thereof may be implemented in code (for example, as communications management software or firmware) executed by at least one processor (for example, referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (for example, configured as or otherwise supporting, individually or collectively, a means for performing the functions described in the present disclosure).

In some examples, the communications manager 920 may be configured to perform various operations (for example, receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for transmitting, to a UE, configuration information that indicates the UE can transmit a request to provide an uplink measurement report for one or more uplink parameters associated with an uplink channel between the UE and a network entity. The communications manager 920 is capable of, configured to, or operable to support a means for receiving, from the UE, the request to provide the uplink measurement report. The communications manager 920 is capable of, configured to, or operable to support a means for transmitting a resource allocation to the UE for transmission of the uplink measurement report. The communications manager 920 is capable of, configured to, or operable to support a means for receiving the uplink measurement report using uplink resources indicated in the resource allocation.

By including or configuring the communications manager 920 in accordance with examples as described herein, the device 905 (for example, at least one processor controlling or otherwise coupled with the receiver 910, the transmitter 915, the communications manager 920, or a combination thereof) may support techniques for UE uplink beam reporting as discussed herein, which may enhance communications reliability and provide for reduced latency.

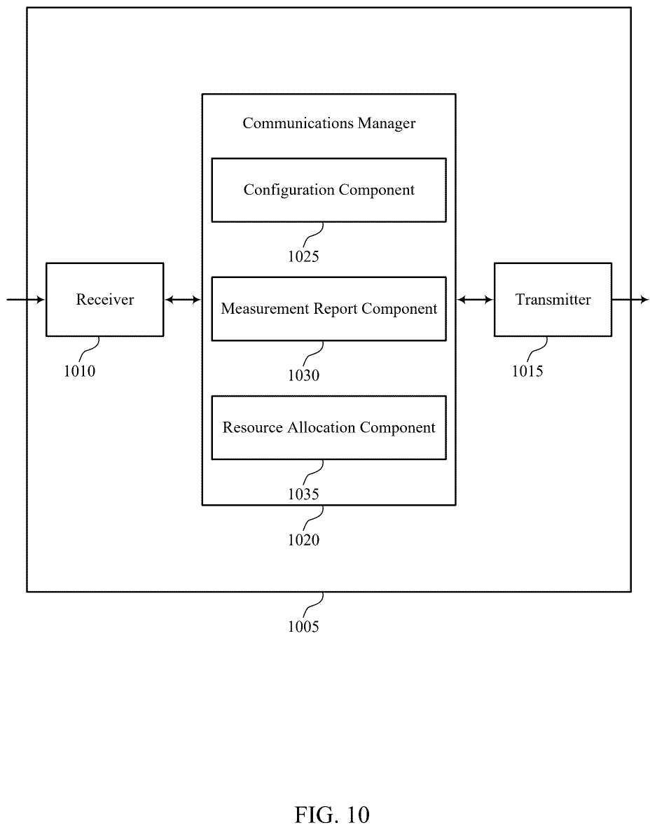

FIG. 10 shows a block diagram of a device 1005 that supports UE uplink beam reporting in wireless communications in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one of more components of the device 1005 (for example, the receiver 1010, the transmitter 1015, the communications manager 1020), may include at least one processor, which may be coupled with at least one memory, to support the described techniques. Each of these components may be in communication with one another (for example, via one or more buses).

The receiver 1010 may provide a means for obtaining (for example, receiving, determining, identifying) information such as user data, control information, or any combination thereof (for example, I/Q samples, symbols, packets, protocol data units, service data units) associated with various channels (for example, control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (for example, electrical, fiber optic) interfaces, wireless interfaces, or any combination thereof.

The transmitter 1015 may provide a means for outputting (for example, transmitting, providing, conveying, sending) information generated by other components of the device 1005. For example, the transmitter 1015 may output information such as user data, control information, or any combination thereof (for example, I/Q samples, symbols, packets, protocol data units, service data units) associated with various channels (for example, control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (for example, electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of UE uplink beam reporting in wireless communications as described herein. For example, the communications manager 1020 may include a configuration component 1025, a measurement report component 1030, a resource allocation component 1035, or any combination thereof. The communications manager 1020 may be an example of aspects of a communications manager 920 as described herein. In some examples, the communications manager 1020, or various components thereof, may be configured to perform various operations (for example, receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The configuration component 1025 is capable of, configured to, or operable to support a means for transmitting, to a UE, configuration information that indicates the UE can transmit a request to provide an uplink measurement report for one or more uplink parameters associated with an uplink channel between the UE and a network entity. The measurement report component 1030 is capable of, configured to, or operable to support a means for receiving, from the UE, the request to provide the uplink measurement report. The resource allocation component 1035 is capable of, configured to, or operable to support a means for transmitting a resource allocation to the UE for transmission of the uplink measurement report. The measurement report component 1030 is capable of, configured to, or operable to support a means for receiving the uplink measurement report using uplink resources indicated in the resource allocation.

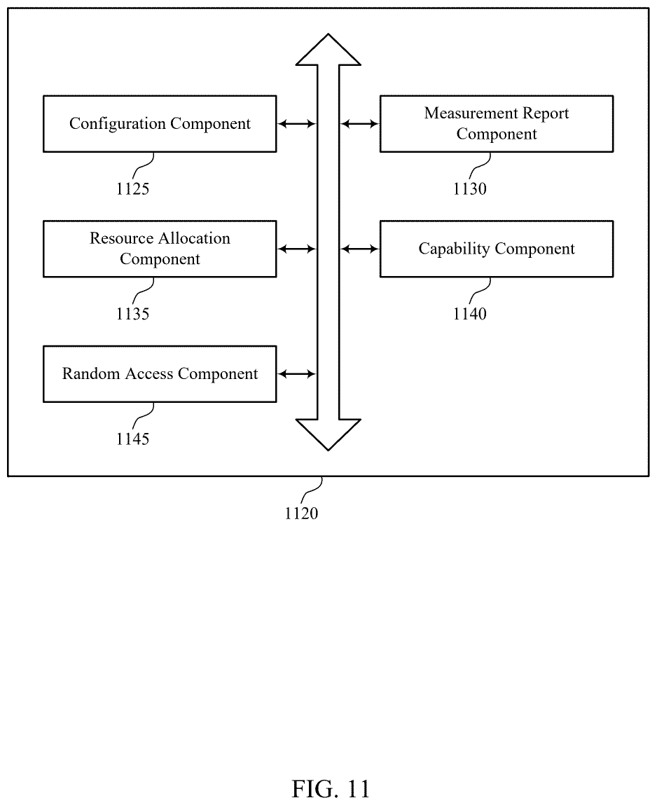

FIG. 11 shows a block diagram of a communications manager 1120 that supports UE uplink beam reporting in wireless communications in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of UE uplink beam reporting in wireless communications as described herein. For example, the communications manager 1120 may include a configuration component 1125, a measurement report component 1130, a resource allocation component 1135, a capability component 1140, a random access component 1145, or any combination thereof. Each of these components, or components or subcomponents thereof (for example, one or more processors, one or more memories), may communicate, directly or indirectly, with one another (for example, via one or more buses). The communications may include communications within a protocol layer of a protocol stack, communications associated with a logical channel of a protocol stack (for example, between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The configuration component 1125 is capable of, configured to, or operable to support a means for transmitting, to a UE, configuration information that indicates the UE can transmit a request to provide an uplink measurement report for one or more uplink parameters associated with an uplink channel between the UE and a network entity. The measurement report component 1130 is capable of, configured to, or operable to support a means for receiving, from the UE, the request to provide the uplink measurement report. The resource allocation component 1135 is capable of, configured to, or operable to support a means for transmitting a resource allocation to the UE for transmission of the uplink measurement report. In some examples, the measurement report component 1130 is capable of, configured to, or operable to support a means for receiving the uplink measurement report using uplink resources indicated in the resource allocation.

In some examples, the one or more uplink parameters include a beam pattern of an uplink beam, an uplink power backoff at the UE for uplink transmissions via one or more uplink beams, a set of available uplink antenna ports at the UE, or any combination thereof.

In some examples, the request to provide the uplink measurement report indicates a request to provide both the uplink measurement report and a downlink measurement report.

In some examples, the request to provide the uplink measurement report is indicated by a request field in an uplink control information transmission, a configured uplink control channel resource, one or more request bits of a downlink beam measurement report, an uplink random access channel resource, an uplink random access channel preamble, or any combination thereof.

In some examples, the capability component 1140 is capable of, configured to, or operable to support a means for receiving, from the UE, a capability indication that indicates a UE capability to request to transmit the uplink measurement report.

In some examples, the configuration information indicates that the request is to be transmitted by the UE using one or more of an uplink control information transmission, a scheduling request, a random access message using a random access resource configured for transmitting the request, or a random access preamble that indicates the request.

In some examples, the resource allocation is transmitted in a downlink control information message that indicates an uplink resource for transmission of the uplink measurement report, and the downlink control information message has a format associated with the uplink measurement report.

In some examples, the request is received in a random access message, and the resource allocation is transmitted in a random access response that indicates an uplink resource for the uplink measurement report.

In some examples, the resource allocation is a first resource allocation of a set of multiple resource allocations configured prior to transmission of the request, and the first resource allocation is within a configured duration subsequent to transmission of the request to provide the uplink measurement report.

In some examples, at least a first uplink measurement value of a least a first uplink parameter of the one or more uplink parameters included in the uplink measurement report is in accordance with one or more of a measurement of a downlink reference signal, an offset associated with the measurement, or assistance information provided to the UE for the first uplink parameter.

In some examples, the uplink measurement report includes one or more of an uplink reference signal received power (RSRP) estimation that is in accordance with a downlink RSRP measurement of a reference signal, a nominal or maximum uplink transmit power of the UE, an offset value, a maximum permissible exposure (MPE) metric, a power headroom value, an uplink signal to interference and noise ratio (SINR), or an uplink throughput value.

In some examples, the uplink measurement report includes an uplink reference signal received power (RSRP) estimation that is in accordance with a downlink pathloss estimate derived from a downlink reference signal and an uplink transmit power of the UE.

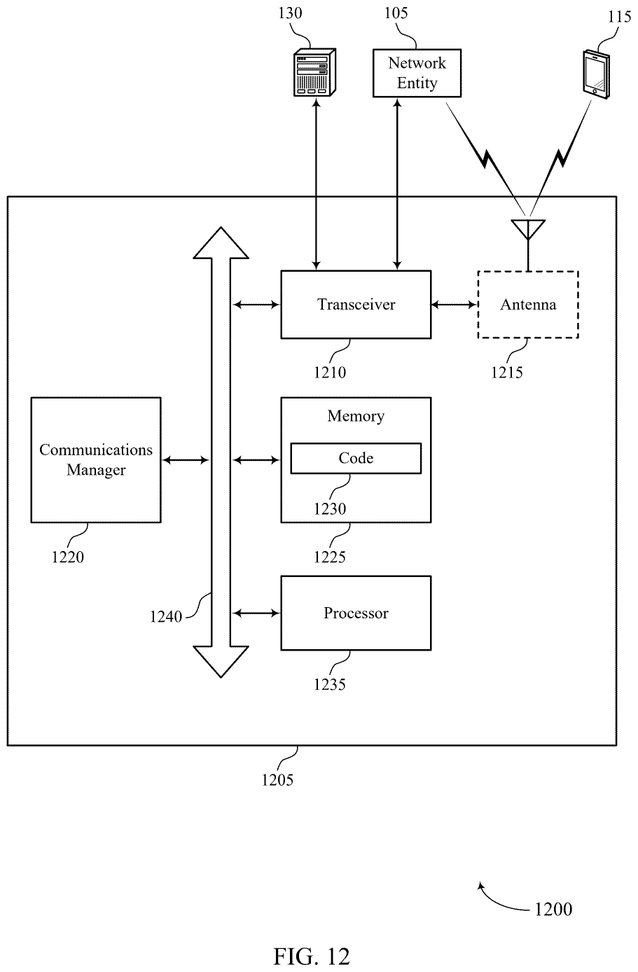

FIG. 12 shows a diagram of a system 1200 including a device 1205 that supports UE uplink beam reporting in wireless communications in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (for example, operatively, communicatively, functionally, electronically, electrically) via one or more buses (for example, a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (for example, concurrently). The transceiver 1210 may also include a modem to modulate signals, to provide the modulated signals for transmission (for example, by one or more antennas 1215, by a wired transmitter), to receive modulated signals (for example, from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (for example, the at least one processor 1235, the at least one memory 1225, or both), may be included in a chip or chip assembly that is installed in the device 1205. In some examples, the transceiver 1210 may be operable to support communications via one or more communications links (for example, communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (for example, when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (for example, one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (for example, one or more of the at least one memory 1225) to cause the device 1205 to perform various functions (for example, functions or tasks supporting UE uplink beam reporting in wireless communications). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (for example, one or more physical nodes and supporting software such as operating systems, virtual machines, or container instances) that may host the functions (for example, by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (for example, within) a protocol layer of a protocol stack. In some examples, a bus 1240 may support communications associated with a logical channel of a protocol stack (for example, between protocol layers of a protocol stack), which may include communications performed within a component of the device 1205, or between different components of the device 1205 that may be co-located or located in different locations (for example, where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (for example, via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (for example, in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for transmitting, to a UE, configuration information that indicates the UE can transmit a request to provide an uplink measurement report for one or more uplink parameters associated with an uplink channel between the UE and a network entity. The communications manager 1220 is capable of, configured to, or operable to support a means for receiving, from the UE, the request to provide the uplink measurement report. The communications manager 1220 is capable of, configured to, or operable to support a means for transmitting a resource allocation to the UE for transmission of the uplink measurement report. The communications manager 1220 is capable of, configured to, or operable to support a means for receiving the uplink measurement report using uplink resources indicated in the resource allocation.

By including or configuring the communications manager 1220 in accordance with examples as described herein, the device 1205 may support techniques for UE uplink beam reporting as discussed herein, which may enhance communications reliability and provide for reduced latency.

In some examples, the communications manager 1220 may be configured to perform various operations (for example, receiving, obtaining, monitoring, outputting, transmitting) using or otherwise in cooperation with the transceiver 1210, the one or more antennas 1215 (for example, where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of UE uplink beam reporting in wireless communications as described herein, or the at least one processor 1235 and the at least one memory 1225 may be otherwise configured to, individually or collectively, perform or support such operations.

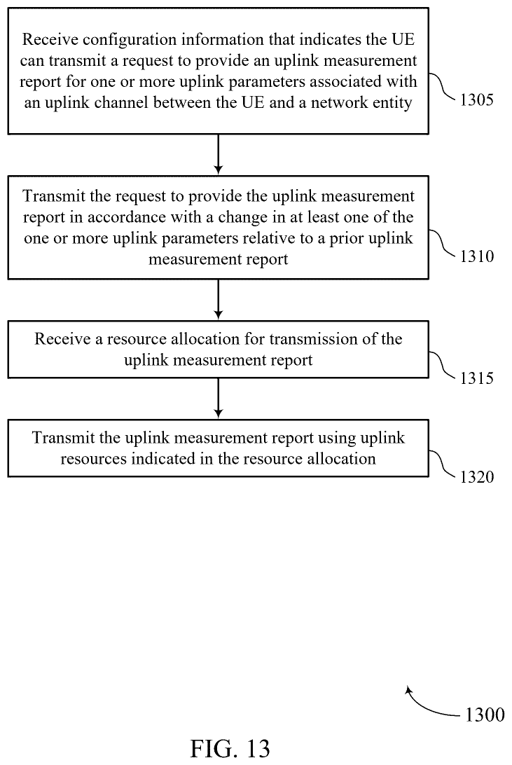

FIG. 13 shows a flowchart illustrating a method 1300 that supports UE uplink beam reporting in wireless communications in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving configuration information that indicates the UE can transmit a request to provide an uplink measurement report for one or more uplink parameters associated with an uplink channel between the UE and a network entity. The operations of 1305 may be performed in accordance with examples as disclosed herein. In some examples, aspects of the operations of 1305 may be performed by a configuration component 725 as described with reference to FIG. 7.

At 1310, the method may include transmitting the request to provide the uplink measurement report in accordance with a change in at least one of the one or more uplink parameters relative to a prior uplink measurement report. The operations of 1310 may be performed in accordance with examples as disclosed herein. In some examples, aspects of the operations of 1310 may be performed by a measurement report component 730 as described with reference to FIG. 7.

At 1315, the method may include receiving a resource allocation for transmission of the uplink measurement report. The operations of 1315 may be performed in accordance with examples as disclosed herein. In some examples, aspects of the operations of 1315 may be performed by a resource allocation component 735 as described with reference to FIG. 7.

At 1320, the method may include transmitting the uplink measurement report using uplink resources indicated in the resource allocation. The operations of 1320 may be performed in accordance with examples as disclosed herein. In some examples, aspects of the operations of 1320 may be performed by a measurement report component 730 as described with reference to FIG. 7.

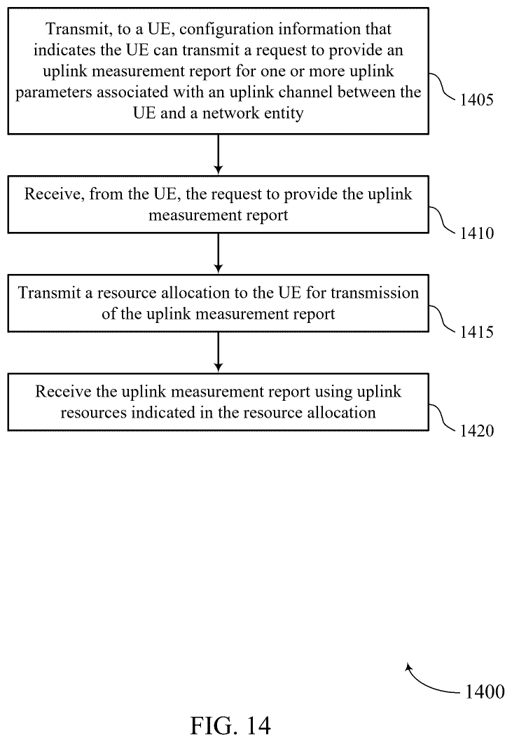

FIG. 14 shows a flowchart illustrating a method 1400 that supports UE uplink beam reporting in wireless communications in accordance with one or more aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include transmitting, to a UE, configuration information that indicates the UE can transmit a request to provide an uplink measurement report for one or more uplink parameters associated with an uplink channel between the UE and a network entity. The operations of 1405 may be performed in accordance with examples as disclosed herein. In some examples, aspects of the operations of 1405 may be performed by a configuration component 1125 as described with reference to FIG. 11.

At 1410, the method may include receiving, from the UE, the request to provide the uplink measurement report. The operations of 1410 may be performed in accordance with examples as disclosed herein. In some examples, aspects of the operations of 1410 may be performed by a measurement report component 1130 as described with reference to FIG. 11.

At 1415, the method may include transmitting a resource allocation to the UE for transmission of the uplink measurement report. The operations of 1415 may be performed in accordance with examples as disclosed herein. In some examples, aspects of the operations of 1415 may be performed by a resource allocation component 1135 as described with reference to FIG. 11.

At 1420, the method may include receiving the uplink measurement report using uplink resources indicated in the resource allocation. The operations of 1420 may be performed in accordance with examples as disclosed herein. In some examples, aspects of the operations of 1420 may be performed by a measurement report component 1130 as described with reference to FIG. 11.

The following provides an overview of clauses of the present disclosure:

Clause 1: A method for wireless communications at a UE, comprising: receiving configuration information that indicates the UE can transmit a request to provide an uplink measurement report for one or more uplink parameters associated with an uplink channel between the UE and a network entity; transmitting the request to provide the uplink measurement report in accordance with a change in at least one of the one or more uplink parameters relative to a prior uplink measurement report; receiving a resource allocation for transmission of the uplink measurement report; and transmitting the uplink measurement report using uplink resources indicated in the resource allocation.

Clause 2: The method of clause 1, wherein the one or more uplink parameters include a beam pattern of an uplink beam, an uplink power backoff at the UE for uplink transmissions via one or more uplink beams, a set of available uplink antenna ports at the UE, or any combination thereof.

Clause 3: The method of any of clauses 1 through 2, wherein the request to provide the uplink measurement report indicates a request to provide both the uplink measurement report and a downlink measurement report.

Clause 4: The method of any of clauses 1 through 3, wherein the request to provide the uplink measurement report is indicated by a request field in an uplink control information transmission, a configured uplink control channel resource, one or more request bits of a downlink beam measurement report, an uplink random access channel resource, an uplink random access channel preamble, or any combination thereof.

Clause 5: The method of any of clauses 1 through 4, further comprising: transmitting a capability indication that indicates a UE capability to request to transmit the uplink measurement report.

Clause 6: The method of any of clauses 1 through 5, wherein the configuration information indicates that the request is to be transmitted using one or more of an uplink control information transmission, a scheduling request, a random access message using a random access resource configured for transmitting the request, or a random access preamble that indicates the request.

Clause 7: The method of any of clauses 1 through 6, wherein the resource allocation is received in a downlink control information message that indicates an uplink resource for transmission of the uplink measurement report, and the downlink control information message has a format associated with the uplink measurement report.

Clause 8: The method of any of clauses 1 through 7, wherein the request is transmitted in a random access message, and the resource allocation is received in a random access response that indicates an uplink resource for the uplink measurement report.

Clause 9: The method of any of clauses 1 through 8, wherein the resource allocation is a first resource allocation of a plurality of resource allocations configured prior to transmission of the request, and the first resource allocation is within a configured duration subsequent to transmitting the request to provide the uplink measurement report.

Clause 10: The method of any of clauses 1 through 9, further comprising: determining at least a first uplink measurement value of at least a first uplink parameter of the one or more uplink parameters to include in the uplink measurement report in accordance with one or more of a measurement of a downlink reference signal, an offset associated with the measurement, or assistance information received from the network entity for the first uplink parameter.

Clause 11: The method of any of clauses 1 through 10, wherein the uplink measurement report includes one or more of an uplink reference signal received power (RSRP) estimation that is in accordance with a downlink RSRP measurement of a reference signal, a nominal or maximum uplink transmit power of the UE, an offset value, a maximum permissible exposure (MPE) metric, a power headroom value, an uplink signal to interference and noise ratio (SINR), or an uplink throughput value.

Clause 12: The method of any of clauses 1 through 11, wherein the uplink measurement report includes an uplink reference signal received power (RSRP) estimation that is in accordance with a downlink pathloss estimate derived from a downlink reference signal and an uplink transmit power of the UE.

Clause 13: A method for wireless communications at a network entity, comprising: transmitting, to a UE, configuration information that indicates the UE can transmit a request to provide an uplink measurement report for one or more uplink parameters associated with an uplink channel between the UE and a network entity; receiving, from the UE, the request to provide the uplink measurement report; transmitting a resource allocation to the UE for transmission of the uplink measurement report; and receiving the uplink measurement report using uplink resources indicated in the resource allocation.

Clause 14: The method of clause 13, wherein the one or more uplink parameters include a beam pattern of an uplink beam, an uplink power backoff at the UE for uplink transmissions via one or more uplink beams, a set of available uplink antenna ports at the UE, or any combination thereof.

Clause 15: The method of any of clauses 13 through 14, wherein the request to provide the uplink measurement report indicates a request to provide both the uplink measurement report and a downlink measurement report.

Clause 16: The method of any of clauses 13 through 15, wherein the request to provide the uplink measurement report is indicated by a request field in an uplink control information transmission, a configured uplink control channel resource, one or more request bits of a downlink beam measurement report, an uplink random access channel resource, an uplink random access channel preamble, or any combination thereof.

Clause 17: The method of any of clauses 13 through 16, further comprising: receiving, from the UE, a capability indication that indicates a UE capability to request to transmit the uplink measurement report.

Clause 18: The method of any of clauses 13 through 17, wherein the configuration information indicates that the request is to be transmitted by the UE using one or more of an uplink control information transmission, a scheduling request, a random access message using a random access resource configured for transmitting the request, or a random access preamble that indicates the request.

Clause 19: The method of any of clauses 13 through 18, wherein the resource allocation is transmitted in a downlink control information message that indicates an uplink resource for transmission of the uplink measurement report, and the downlink control information message has a format associated with the uplink measurement report.

Clause 20: The method of any of clauses 13 through 19, wherein the request is received in a random access message, and the resource allocation is transmitted in a random access response that indicates an uplink resource for the uplink measurement report.

Clause 21: The method of any of clauses 13 through 20, wherein the resource allocation is a first resource allocation of a plurality of resource allocations configured prior to transmission of the request, and the first resource allocation is within a configured duration subsequent to transmission of the request to provide the uplink measurement report.

Clause 22: The method of any of clauses 13 through 21, wherein at least a first uplink measurement value of a least a first uplink parameter of the one or more uplink parameters included in the uplink measurement report is in accordance with one or more of a measurement of a downlink reference signal, an offset associated with the measurement, or assistance information provided to the UE for the first uplink parameter.

Clause 23: The method of any of clauses 13 through 22, wherein the uplink measurement report includes one or more of an uplink reference signal received power (RSRP) estimation that is in accordance with a downlink RSRP measurement of a reference signal, a nominal or maximum uplink transmit power of the UE, an offset value, a maximum permissible exposure (MPE) metric, a power headroom value, an uplink signal to interference and noise ratio (SINR), or an uplink throughput value.

Clause 24: The method of any of clauses 13 through 23, wherein the uplink measurement report includes an uplink reference signal received power (RSRP) estimation that is in accordance with a downlink pathloss estimate derived from a downlink reference signal and an uplink transmit power of the UE.

Clause 25: A UE for wireless communications, comprising one or more memories storing processor-executable code, and one or more processors coupled with the one or more memories and individually or collectively operable to execute the code to cause the UE to perform a method of any of clauses 1 through 12.

Clause 26: A UE for wireless communications, comprising at least one means for performing a method of any of clauses 1 through 12.

Clause 27: A non-transitory computer-readable medium storing code for wireless communications, the code comprising instructions executable by one or more processors to perform a method of any of clauses 1 through 12.

Clause 28: A network entity for wireless communications, comprising one or more memories storing processor-executable code, and one or more processors coupled with the one or more memories and individually or collectively operable to execute the code to cause the network entity to perform a method of any of clauses 13 through 24.

Clause 29: A network entity for wireless communications, comprising at least one means for performing a method of any of clauses 13 through 24.

Clause 30: A non-transitory computer-readable medium storing code for wireless communications, the code comprising instructions executable by one or more processors to perform a method of any of clauses 13 through 24.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (for example, a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (for example, receiving information), accessing (for example, accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive configuration information that indicates the UE can transmit a request to provide an uplink measurement report for one or more uplink parameters associated with an uplink channel between the UE and a network entity;
transmit the request to provide the uplink measurement report in accordance with a change in at least one of the one or more uplink parameters relative to a prior uplink measurement report;
receive a resource allocation for transmission of the uplink measurement report; and
transmit the uplink measurement report using uplink resources indicated in the resource allocation.

2. The UE of claim 1, wherein the one or more uplink parameters include a beam pattern of an uplink beam, an uplink power backoff at the UE for uplink transmissions via one or more uplink beams, a set of available uplink antenna ports at the UE, or any combination thereof.

3. The UE of claim 1, wherein the request to provide the uplink measurement report indicates a request to provide both the uplink measurement report and a downlink measurement report.

4. The UE of claim 1, wherein the request to provide the uplink measurement report is indicated by a request field in an uplink control information transmission, a configured uplink control channel resource, one or more request bits of a downlink beam measurement report, an uplink random access channel resource, an uplink random access channel preamble, or any combination thereof.

5. The UE of claim 1, wherein the one or more processors are individually or collectively further operable to execute the code to cause the UE to:
transmit a capability indication that indicates a UE capability to request to transmit the uplink measurement report.

6. The UE of claim 1, wherein the configuration information indicates that the request is to be transmitted using one or more of an uplink control information transmission, a scheduling request, a random access message using a random access resource configured for transmitting the request, or a random access preamble that indicates the request.

7. The UE of claim 1, wherein the resource allocation is received in a downlink control information message that indicates an uplink resource for transmission of the uplink measurement report, and the downlink control information message has a format associated with the uplink measurement report.

8. The UE of claim 1, wherein the request is transmitted in a random access message, and the resource allocation is received in a random access response that indicates an uplink resource for the uplink measurement report.

9. The UE of claim 1, wherein the resource allocation is a first resource allocation of a plurality of resource allocations configured prior to transmission of the request, and the first resource allocation is within a configured duration subsequent to transmitting the request to provide the uplink measurement report.

10. The UE of claim 1, wherein the one or more processors are individually or collectively further operable to execute the code to cause the UE to:
determine at least a first uplink measurement value of at least a first uplink parameter of the one or more uplink parameters to include in the uplink measurement report in accordance with one or more of a measurement of a downlink reference signal, an offset associated with the measurement, or assistance information received from the network entity for the first uplink parameter.

11. The UE of claim 1, wherein the uplink measurement report includes one or more of an uplink reference signal received power (RSRP) estimation that is in accordance with a downlink RSRP measurement of a reference signal, a nominal or maximum uplink transmit power of the UE, an offset value, a maximum permissible exposure (MPE) metric, a power headroom value, an uplink signal to interference and noise ratio (SINR), or an uplink throughput value.

12. The UE of claim 1, wherein the uplink measurement report includes an uplink reference signal received power (RSRP) estimation that is in accordance with a downlink pathloss estimate derived from a downlink reference signal and an uplink transmit power of the UE.

13. A network entity, comprising:
one or more memories storing processor-executable code; and
one or more processors coupled with the one or more memories and individually or collectively operable to execute the code to cause the network entity to:
transmit, to a user equipment (UE), configuration information that indicates the UE can transmit a request to provide an uplink measurement report for one or more uplink parameters associated with an uplink channel between the UE and a network entity;
receive, from the UE, the request to provide the uplink measurement report;
transmit a resource allocation to the UE for transmission of the uplink measurement report; and
receive the uplink measurement report using uplink resources indicated in the resource allocation.

14. The network entity of claim 13, wherein the one or more uplink parameters include a beam pattern of an uplink beam, an uplink power backoff at the UE for uplink transmissions via one or more uplink beams, a set of available uplink antenna ports at the UE, or any combination thereof.

15. The network entity of claim 13, wherein the request to provide the uplink measurement report indicates a request to provide both the uplink measurement report and a downlink measurement report.

16. The network entity of claim 13, wherein the request to provide the uplink measurement report is indicated by a request field in an uplink control information transmission, a configured uplink control channel resource, one or more request bits of a downlink beam measurement report, an uplink random access channel resource, an uplink random access channel preamble, or any combination thereof.

17. The network entity of claim 13, wherein the one or more processors are individually or collectively further operable to execute the code to cause the network entity to:
receive, from the UE, a capability indication that indicates a UE capability to request to transmit the uplink measurement report.

18. The network entity of claim 13, wherein the configuration information indicates that the request is to be transmitted by the UE using one or more of an uplink control information transmission, a scheduling request, a random access message using a random access resource configured for transmitting the request, or a random access preamble that indicates the request.

19. The network entity of claim 13, wherein the resource allocation is transmitted in a downlink control information message that indicates an uplink resource for transmission of the uplink measurement report, and the downlink control information message has a format associated with the uplink measurement report.

20. The network entity of claim 13, wherein the request is received in a random access message, and the resource allocation is transmitted in a random access response that indicates an uplink resource for the uplink measurement report.

21. A method for wireless communications at a user equipment (UE), comprising:
receiving configuration information that indicates the UE can transmit a request to provide an uplink measurement report for one or more uplink parameters associated with an uplink channel between the UE and a network entity;
transmitting the request to provide the uplink measurement report in accordance with a change in at least one of the one or more uplink parameters relative to a prior uplink measurement report;
receiving a resource allocation for transmission of the uplink measurement report; and
transmitting the uplink measurement report using uplink resources indicated in the resource allocation.

22. The method of claim 21, wherein the request to provide the uplink measurement report is indicated by a request field in an uplink control information transmission, a configured uplink control channel resource, one or more request bits of a downlink beam measurement report, an uplink random access channel resource, an uplink random access channel preamble, or any combination thereof.

23. The method of claim 21, further comprising transmitting a capability indication that indicates a UE capability to request to transmit the uplink measurement report.

24. The method of claim 21, wherein the configuration information indicates that the request is to be transmitted using one or more of an uplink control information transmission, a scheduling request, a random access message using a random access resource configured for transmitting the request, or a random access preamble that indicates the request.

25. The method of claim 21, wherein the resource allocation is received in a downlink control information message that indicates an uplink resource for transmission of the uplink measurement report, wherein the downlink control information message has a format associated with the uplink measurement report.

26. A method for wireless communications at a network entity, comprising:
transmitting, to a user equipment (UE), configuration information that indicates the UE can transmit a request to provide an uplink measurement report for one or more uplink parameters associated with an uplink channel between the UE and a network entity;
receiving, from the UE, the request to provide the uplink measurement report;
transmitting a resource allocation to the UE for transmission of the uplink measurement report; and
receiving the uplink measurement report using uplink resources indicated in the resource allocation.

27. The method of claim 26, wherein the one or more uplink parameters include a beam pattern of an uplink beam, an uplink power backoff at the UE for uplink transmissions via one or more uplink beams, a set of available uplink antenna ports at the UE, or any combination thereof.

28. The method of claim 26, wherein the request to provide the uplink measurement report is indicated by a request field in an uplink control information transmission, a configured uplink control channel resource, one or more request bits of a downlink beam measurement report, an uplink random access channel resource, an uplink random access channel preamble, or any combination thereof.

29. The method of claim 26, wherein the configuration information indicates that the request is to be transmitted by the UE using one or more of an uplink control information transmission, a scheduling request, a random access message using a random access resource configured for transmitting the request, or a random access preamble that indicates the request.

30. The method of claim 26, wherein the resource allocation is transmitted in a downlink control information message that indicates an uplink resource for transmission of the uplink measurement report, wherein the downlink control information message has a format associated with the uplink measurement report.
